(19) United States
(12) Patent Application Publication
(10) Pub. No.: US 2022/0032982 A1
(43) Pub. Date: Feb. 3, 2022

(54) VEHICLE POSITION IDENTIFICATION

(71) Applicant: RELIABLE DATA SYSTEMS INTERNATIONAL LIMITED, Surrey (GB)

(72) Inventors: Richard David SHENTON, Surrey (GB); José Eduardo Fernandes Canelas LOPES, Hampshire (GB)

(21) Appl. No.: 17/275,997

(22) PCT Filed: Sep. 13, 2019
(86) PCT No.: PCT/GB2019/052579

§ 371 Date: Mar. 12, 2021

(30) Foreign Application Priority Data
Sep. 14, 2018 (GB) GB1814982.3

(51) Int. Cl. B61L 25/02; G06K 9/00; G06T 7/579; G06T 7/70; G06F 16/587; G06F 16/23

(52) U.S. Cl. CPC B61L 25/025; G06K 9/00791; G06K 9/00744; G06T 7/579; G06T 2207/30252; G06F 16/587; G06F 16/2365; B61L 2205/04; G06T 2207/10016; G06T 7/70

(57) ABSTRACT

A method for determining a location of a vehicle driving on a track is provided, the method comprising the step of obtaining a real-time image from an imaging device (100) located on the vehicle and deriving information from the obtained real-time image. The derived information is compared with a database comprising derived information from a plurality of images, each of the plurality of images being associated with a specific track segment. The closest match is then determined between a sequence of the real-time images to a sequence of the plurality of images, and the location of the vehicle on a track segment is identified based on the specific track segment associated with the closest matched sequence of images. The track segments are associated with a specific track amongst a set of parallel or closely spaced tracks.

### FIELD OF TECHNOLOGY

The present invention relates to the field of vehicle location, and more particularly, but not exclusively, to determining location of a vehicle driving on tracks such as a train.

### BACKGROUND OF THE INVENTION

There are many situations where it is desirable or important to identify the location of a vehicle. Further, and in relation to rail transport vehicles (for example, but not exclusively, trains and trams), it may be particularly desirable to locate the specific track or section of track on which the vehicle lies.

A train's location on a specific track has been typically detected using track circuits and axle counters. Increasingly, train control systems are being deployed which use transponders placed in the track and as a transponder reader in the train passes over the transponder, the track location of the train is confirmed. All of these methods require track-based infrastructure which is expensive to install and maintain.

GPS or other global navigation satellite systems (GNSS) are also occasionally used for train control and other operational applications, but these are not sufficiently accurate for dense areas with multiple parallel tracks and crossings. Such systems cannot always identify which of several closely located tracks a train is on. Hence GPS has only been used to date on remote or low density lines (for example the Rio Tinto heavy freight line in Western Australia).

Image analysis has been used to identify rails and tracks in a captured scene ahead of a train, and to deduce which track the train is on. These techniques suffer from a need to know which tracks are visible from a given location, in order to determine exactly which track the train currently is on. For example, there may be two parallel tracks on a map, but one may be obscured from the other by vegetation or height differences in some locations. In such a case, where at least one of the tracks is obscured, image analysis would be unable to determine which track the train was on. In addition, tracks are not always visible, for example, if the tracks are covered by snow.

Much research and development has been undertaken into position location from video, largely related to autonomous vehicles. These techniques typically employ some form of matching of features in the real-time image with features from historical images recorded over the same route.

One such technique is termed sequence SLAM (simultaneous location and mapping). This technique has been shown to be robust to changes in environmental conditions including changes from day to night and from summer to winter, for example as discussed by Milford, M. and Wyeth, G. (2012) (SeqSLAM: Visual route-based navigation for sunny summer days and stormy winter nights. 2012 IEEE International Conference on Robotics and Automation).

One reported weakness of the sequence SLAM technique is its sensitivity to camera position. If the camera is in a different position in the road (eg different lanes) on different journeys the matching process may fail. In addition, the technique will fail when the scene is largely obscured, for example in dense fog.

There is therefore a need for an improved way of determining specific location which can also operate during periods of temporary obstruction of the field of view of the camera.

### SUMMARY OF THE INVENTION

In accordance with the present invention, a method for determining a location of a vehicle driving on a track is provided. The method comprises obtaining a real-time image from an imaging device located on the vehicle and deriving information from the obtained real-time image. The derived information is then compared with a database comprising derived information from a plurality of images, each of the plurality of images being associated with a specific location. The closest match between a sequence of the real-time images to a sequence of the plurality of images is then determined, and the location of the vehicle is estimated based on the location associated with the closest matched image.

The present invention provides a system and a method to locate trains on a specific track in the railway network, most preferably not requiring track-mounted equipment, but using only equipment mounted in each train. A camera may be installed in each train which is used to record video of the scene ahead. The camera may be a forward facing camera, although cameras facing in other directions are also envisaged. Video images from each train may then be processed and compared to a database of data records, with each data record associated with a specific track location.

The database may be prepared using historical video recorded on previous journeys of the trains on known tracks.

To determine the train position, real-time images provided by a camera mounted on the track vehicle (which may or may not be the same camera used to provide video images for the database) are processed and matched with the data records in the database. The best match between the real-time images and the data records may be used to indicate the train position.

The present invention may utilise track locations that are unique to a specific track. For example, where there are parallel or closely adjacent tracks, the data records on one track may have track locations which are distinct from data records on the parallel or adjacent track, even though the physical separation of the tracks may be small. In this regard, the position determined by the present invention may identify the position of the vehicle on the specific track upon which the vehicle lies.

For trains in particular, or trams, the invention may take advantage of the fact that the motion of the train/tram is constrained by the track. As a result, at a specific point on a particular stretch of track, the viewing angle of a train-mounted camera, e.g. a forward facing camera, will be similar from journey to journey. Therefore the scenes captured by the camera at this point on different journeys will align well. Furthermore, the scenes will not align well with images taken on a parallel or adjacent track at the equivalent point. This property can allow the matching process to determine the specific track segment on which the train is travelling.

On occasions, the view ahead will be limited, for example by fog. Nevertheless, the area of the track just ahead of the train is typically still visible. The present invention may utilise this fact by using a lower portion of the real-time images that are provided by the camera mounted on the track vehicle in the matching process to discriminate between candidate tracks in the area. In this case the candidate tracks can be identified by using a less precise train location (for example, from GNSS) which is maintained by the system. Similarly, sometimes the view to the left or right will be obscured e.g. by one or more other trains. Such situations may be recognised by the system and a precise location will be unavailable until the view is cleared.

Preferably, the location of the track vehicle may be initially be approximated, for example by GNSS fix, manual input or a comparison of real-time images to the entire database. Once this approximate location is known, the information from the real-time image may be compared with only the information of images that are associated with a location within the approximated location range, to determine the closest match of the real-time images to the database of images.

Over time, the view ahead of the train will change. For example, new buildings will be constructed and trees will be felled, which can affect the performance of the system. In preferred embodiments, statistics on the quality of the matches at each location may continually be gathered. Once the quality drops below a certain threshold the data records for that location can be replaced by data records derived from more recently recorded videos.

### BRIEF DESCRIPTION OF THE DRAWINGS

FIG. 1 shows an example of a system for recording a database of images and related track position.

FIG. 2 shows an example of a sequential series of images and their corresponding association with track position.

FIG. 3 shows an example of a system for real time operation of identifying a position of a train.

FIG. 4a shows schematically the location of a general area in which the train may be located.

FIG. 4b shows a schematic representation of all of the possible paths that are extracted from the general area shown in FIG. 4a in which the train is located.

FIG. 4c shows schematically the matching of the live video sequence to the possible paths identified.

### DETAILED DESCRIPTION OF THE INVENTION

Whilst the present invention will be described mainly with reference to its use with trains, it is envisaged that the apparatus and method provided herein could also be utilised in locating other forms of vehicle, particularly other track vehicles such as trams.

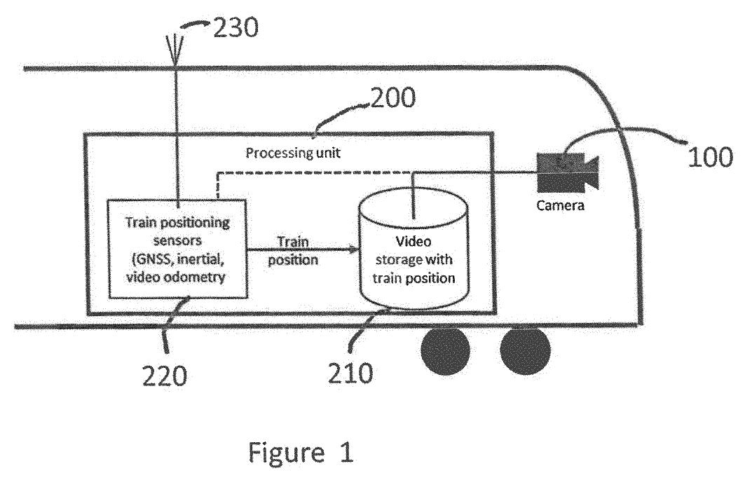

As can be seen in FIG. 1, a train is fitted with at least one camera 100, which provides a real-time video feed to a processing unit 200. The camera may be forward facing and may provide a real-time video feed of the scene ahead. Whilst preferably the at least one camera may be a forward facing camera mounted to the train, it is also envisaged that the at least one camera may be arranged in other orientations.

It is also feasible that the video feed is not real-time, and a timing factor can be incorporated into the image processing to take this into account.

The processing unit 200 incorporates at least one system for estimating the location of a train, for example a receiver 230, such as a GNSS receiver, and a dead reckoning system 220. The dead reckoning system 220 may operate using the camera images provided by the at least one camera 100 and a visual odometry technique, an inertial system with gyroscopes and/or accelerometers, information provided by an odometer of the train, other sensors or any combination of the above. Other methods of operating the dead reckoning system are also envisaged.

A database of images may be populated by providing a video feed from the at least one camera 100, and storing the video feed on non-volatile memory 210. For each video frame, the location and speed of the train given by the receiver 230 and/or the dead-reckoning system 220 is also recorded, and stored in non-volatile memory 210.

The video and positioning data may then be recovered from the train and processed.

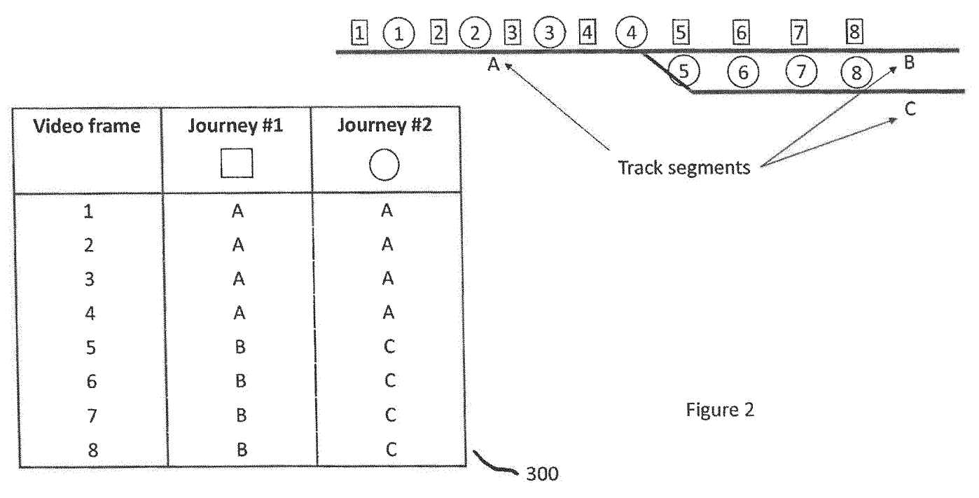

With reference to FIG. 2, each video frame in the database of images is then associated with a location. The location may comprise the location along the track measured by the receiver 230 and/or the dead reckoning system 220. Additionally or alternatively, each video frame may be associated with a particular track segment on a track map (e.g. one or more of track segments A, B and C), wherein a track segment is a unique stretch of track, for example between two sets of points or switches.

If a precise geospatial track map is available with accuracy better than the separation between parallel tracks, the track segments may be defined by geospatial coordinates, for example latitude and longitude. If a precise map is not available, each track segment may be identified by a reference name, such as ‘Up Fast’ or‘Up Slow’ in the UK, or other naming conventions.

The matching of video frames to track segments may be carried out manually by visual inspection of the video, and associating each video frame with a specific track segment, or by automated means such as by using image processing to identify switches and crossings in the video and to match these with segments in the track map.

For example, two journeys are shown schematically in FIG. 2. Track A in FIG. 2 splits into two tracks, track B and track C. In the first journey, video frames 1 to 4 are all taken along, and therefore may be associated with track A. When track A splits into two tracks, the train continues along track B, and video frames 5 to 8 are all taken along, and therefore may be associated with track B.

Similarly, in the second journey, the train proceeds along track A, and therefore the first 4 video frames are taken on, and therefore may be associated with track A. However, in the second journey and when the track splits, the train proceeds along track C. Video frames 5 to 8 are therefore al taken along, and may be associated with track C. Table 300 shows the association of each video frame in each journey with their respective track segment A, B or C.

Once all of the video frames have been associated with a location and/or a specific track segment, the size of the database may then be reduced to enable faster real-time processing. For example, the number of video frames can be reduced so that they are evenly spaced, for example approximately once every 10 m. Alternatively, the number of video frames may be reduced such that they are not evenly spaced. For example, in order to provide improved accuracy at certain locations, there might be 10 m resolution for plain open line tracks and 1 m resolution for precise stopping at stations.

In addition, the video frames of the database can be pre-processed in preparation for later processing, for example by using the sequence SLAM technique, wherein the images are reduced in size to 64×32 pixels and are patch normalised. The resulting processed data may then form a data record in the database for that location on that track segment.

Together with a geographical track map, the resulting database may then be distributed to train-borne systems for use in real-time location.

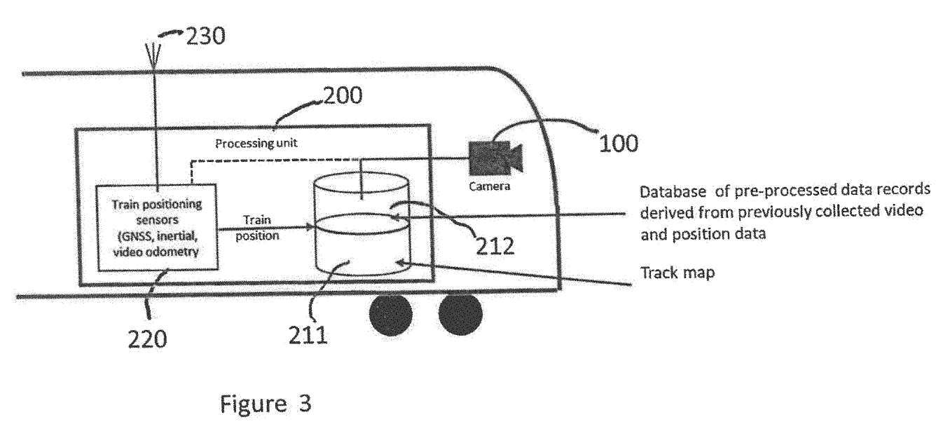

With reference to FIG. 3, the same equipment previously installed for recording for the database may then be used for real-time operation. The non-volatile memory may further comprise at least one track map 211 and at least one database 212. The database 212 may consist of pre-processed data records derived from previously collected video and position data, as described above.

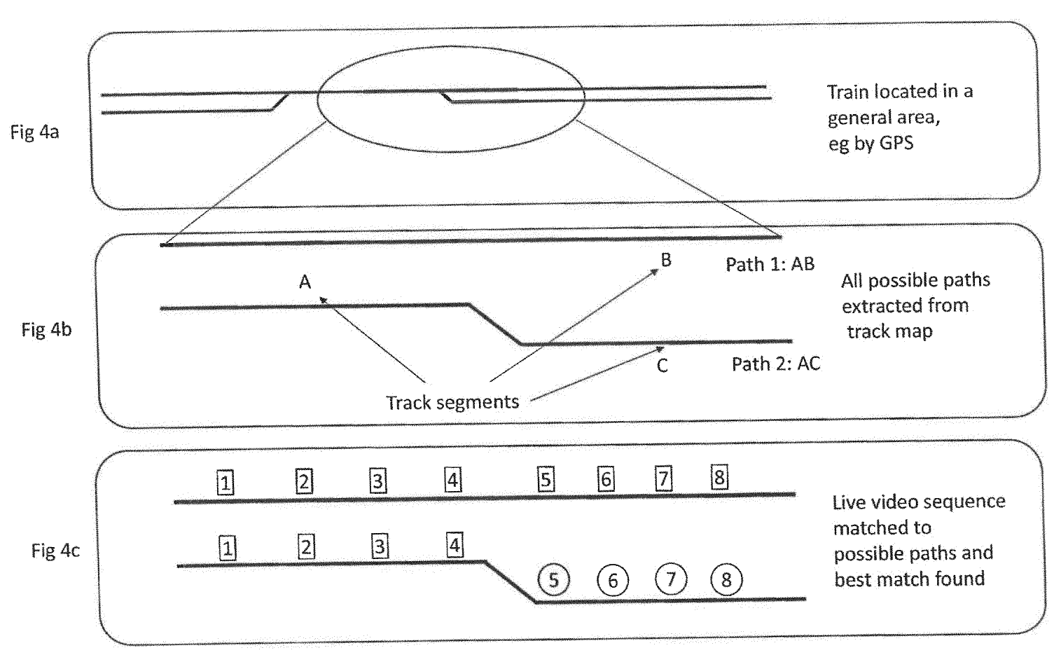

A method for determining the location of a train on a track is shown in FIGS. 4a to 4c.

As can be seen in FIG. 4a, when switched on, the system may obtain an approximate location 401 for the train, for example by GNSS fix, manual input or a comparison of real-time images to the entire database, for example a sequence SLAM search of the entire database. Other methods of obtaining the approximate location of the train are also considered. Alternatively, this estimating step can be omitted. The step estimated is preferred, though, as it reduces the amount of image processing required on comparing current images with the database images.

With reference to FIG. 4b, once the approximate location is known, the processing unit may identify all possible paths that the train may follow in the general area. For example, the processing unit 200 may use the track map 211 to identify all possible track segments in the local area. From these track segments, a database of all possible train paths may be assembled. A train path takes account of a route that a train might take through a switch or crossing. For example, a track segment A might diverge at a set of points into either track segment B or track segment C. There are two possible train paths AB and AC, so the database may join together local area data records for A and B to form one entry in the path database. The other entry would be formed by the records from A and C.

With reference to FIG. 4c, the actual location of the train is determined. A real-time video stream is taken from the camera 100 and compared to a database (such as the database as populated above) to determine the actual location of the train, more precisely. A knowledge of the train speed (for example, as determined by the receiver 230 and/or the dead-reckoning system) may be used to select a sequence of real-time frames (e.g. 10 frames) which are approximately separated by the same spacing as the data record in the database (for example frames that are separated by 10 meters).

The sequence of real-time frames may then be pre-processed following the sequence SLAM method (down sized and patch normalised) and then matched using sequence SLAM to the data records in the database. The resulting match may provide the system estimate of the train location on a specific track, the specific track preferably being one of the possible paths extracted from the track map as shown in FIG. 4b, identified within the general area of the train shown in FIG. 4a.

Over time the forward facing scene will change. For example, buildings and structures might be constructed or removed, or tress might be felled. It is therefore necessary to keep the system database up-to-date.

The present invention may further provide a way of maintaining the database by storing statistics on the real-time matches on the train. These statistics can be used to identify where the quality of the match at certain locations has deteriorated over time. Once the quality statistics have dropped below a certain threshold, the existing database records may be replaced by more up-to-date images derived from recently recorded video from a train. Said up-to-date images will more closely reflect the current forward facing scene.

The track location technique can be combined with GNSS or other position tracking and dead reckoning approaches to improve the overall performance of the system. In this regard, the vehicle position may be considered as being made up of two components: the position on a track map in the longitudinal direction along the track, and the vehicle's cross track position, i.e. which specific track amongst a set of parallel or closely spaced tracks the vehicle lies on.

GNSS, dead reckoning approaches and the like may be able to relatively precisely determine the along track position of the vehicle, but may not be sufficiently accurate to determine the cross-track position, i.e. which track the vehicle is on. However, image matching techniques may be particularly adept at determining the cross-track position, but may struggle to determine an accurate along track position, particularly on long, featureless straight track sections.

For example, on open stretches of straight line, the image matching system may be able to discriminate the correct track, but may struggle to be accurate in the longitudinal direction (i.e. where exactly the train lies along the specific track). Therefore, by combining GNSS (or other positioning information) with the track information from the image matching as described herein, a precise location in both the along track and cross-track position may be obtained.

A similar approach may be utilised for improved operation in fog or smoke. In such a case, a partition of the database might correspond to data records derived from the lower portion of the forward facing images. This portion of the image is closest to the train and is less susceptible to fog obscuration. Matching against these records would provide for the cross-track position, if not the along track position. The absolute position in this case may then be determined by GNSS and dead reckoning measurements, combined with the track discrimination of the image matching.

Should the location fix be lost, dead reckoning using odometry (for example visual, inertial or wheel based odometry) can be used to update the train position from the last known position until such time as a good GNSS or image matching fix is obtained. When an accurate position has been determined, this may then be used to account for any accumulated errors in the odometry tracking.

The same approach could be used during periods of temporary obscuration of the scene ahead, for example, when there are other trains to the left or right, or for low-angle sunlight directly into the lens of the camera

For improved performance at day or night, in different seasons or in other different conditions, the database might be partitioned with different sets of data records. For example, day records might be used during day operation and the night records at night.

For improved accuracy at certain locations, data records might be stored (and searched) at different resolutions. For example, there might be 10 m resolution for plain open line and 1 m resolution for precise stopping at stations. In such a case, when there is a larger separation between data records (for example 10 meters between each data record) multiple real-time sequences may be generated to find the best match to the data records. For example if the train is moving at 1 m/video frame, a sequence could be formed from frame 1, frame 11, frame 21 . . . and a second sequence could be formed from frame 2, frame 22, frame 32 . . . . The sequence which best matches the data records may then be used to determine the point at which the train was best aligned with the position in the database.

It may not be possible to install cameras at the same height and pointing angle relative to the ground in all trains (for example, because of different designs of train cabs). To allow for different camera poses, the video image might be automatically adjusted to improve the alignment between stored and live images when the train is at a specific point. This process might make use of the fixed position of the tracks to determine the adjustments to be made (for example, using image translation or rotation).

Whilst the present invention will be described mainly in reference to its use with trains, it is envisaged that the apparatus and method provided herein could also be utilised in locating other forms of vehicle.

Although this disclosure has been described in terms of preferred examples, it should be understood that these examples are illustrative only and that the claims are not limited to those examples. Those skilled in the art will be able to make modifications and alternatives in view of the disclosure which are contemplated as falling within the scope of the appended claims

1. A method for determining a location of a vehicle driving on a track, the method comprising:
obtaining a real-time image from an imaging device located on the vehicle;
deriving information from the obtained real-time image;
comparing the derived information with a database comprising derived information from a plurality of images, each of the plurality of images being associated with a specific track segment;
determining the closest match between a sequence of the real-time images to a sequence of the plurality of images;
identifying the location of the vehicle on a track segment based on the specific track segment associated with the closest matched sequence of images;
wherein the track segments are associated with a specific track amongst a set of parallel or closely spaced tracks.

2. The method of claim 1, wherein the vehicle is a train.

3. The method of claim 1, the method further comprising:
establishing the database comprising derived information from the plurality of images.

4. The method of claim 3, wherein the establishing the database comprising derived information from the plurality of images further comprises:
providing a video feed from the imaging device located on the vehicle;
recording positioning data of the vehicle;
recovering the video feed and positioning data of the vehicle;
processing the video feed and positioning data of the vehicle; and
associating each frame of the video feed with the corresponding positioning data.

5. The method of claim 4, wherein the associating each frame of the video feed comprises associating each frame of the video feed with a track segment on a track map

6. The method of claim 4, wherein the each frame of the video feed is associated with the corresponding positioning data by automated means.

7. The method of claim 3, the method further comprising:
reducing the size of the database to enable faster real-time processing.

8. The method of claim 7, wherein the reducing the size of the database comprises reducing the number of video frames so that they are more sparsely spaced

9. The method of claim 3, the method further comprising:
pre-processing each frame of the video feed using a sequence SLAM technique to reduce the images in size and to patch normalize each video frame.

10. The method of any preceding claim, the method further comprising:
storing statistics on the matching of the real-time image to one of the plurality of images;
identifying where the quality of the match at certain locations has deteriorated over time;
when the quality of the match has dropped below a threshold, replacing the image in the database with a more up-to-date image.

11. The method of claim 1, the method further comprising:
estimating a location range of the vehicle;
wherein the derived information from the obtained real-time image is compared with derived information from the plurality of images associated with the estimated location range of the vehicle.

12. The method of any claim 1, the method further comprising:
identifying all possible track segments in the location range of the vehicle using a track map;
assembling a database of all possible train paths from the possible track segments; and wherein the estimating the location of the vehicle includes providing the system estimate of the train location on a specific train path.

13. The method of claim 11, wherein the location range of the vehicle is estimated by GNSS fix, manual input or a comparison of real-time images to the entire database.

14. The method of claim 13, the method further comprising:
determining the along track position of the vehicle by GNSS fix or other positioning system; and wherein the identifying the location of the vehicle is further based on the along track position of the vehicle determined by GNSS fix or other positioning system

15. A system for determining a position of a vehicle driving on a track, the system comprising:
an imaging device on the vehicle configured to provide real-time images;
means for deriving information from the obtained real-time image from the imaging device;
means for comparing the derived information with a database comprising derived information from a plurality of images, each of the plurality of images being associated with a specific track segment;
means for determining the closest match between a sequence of the real-time images to a sequence of the plurality of images;
means for identifying the location of the vehicle on a track segment based on the specific track segment associated with the closest matched sequence of images;
wherein the track segments are associated with a specific track amongst a set of parallel or closely spaced tracks.

16. The system of claim 15, wherein the imaging device is forward facing and is configured to provide real-time images of the scene ahead.

17. The system of claim 15, further comprising means for estimating a location range of the vehicle.

18. The system of claim 17, wherein the means for estimating a location range of the vehicle is a GNSS receiver.

19. The system of claim 15, further comprising non-volatile memory containing the database comprising derived information from a plurality of images.
